(19) United States
(12) Patent Application Publication
(10) Pub. No.: US 2016/0049061 A1
(43) Pub. Date: Feb. 18, 2016

(54) INTEGRATED VEHICLE SENSING AND WARNING SYSTEM

(71) Applicant: VIKIE, Inc., Newnan, GA (US)

(72) Inventors: Derek Devaughn Scarborough, Newnan, GA (US); Justin Allen Snyder, Saint Augustine, FL (US); Felix Ruben Astacio, Washington, NJ (US)

(73) Assignee: VIKIE, Inc., Newnan, GA (US)

(21) Appl. No.: 14/825,256

(22) Filed: Aug. 13, 2015

Related U.S. Application Data
(60) Provisional application No. 62/070,031, filed on Aug. 14, 2014.

(51) Int. Cl. G08B 21/02; B60N 2/00

(52) U.S. Cl. CPC G08B 21/02; B60N 2/002

(57) ABSTRACT

The present invention is a system for detecting the presence of a mammal, such as a child, inside a vehicle which is experiencing extreme temperatures. The system initiates one or more alarms such that a passersby, the authorities, the driver, contacts, or the like can rescue the mammal before harm can occur.

This application claims priority of U.S. provisional application No. 62/070,031 filed on Aug. 14, 2014. All applications are incorporated in their entirety by reference.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a system of sensing a living mammal inside a vehicle. In particular, it relates to a system for sensing a living mammal in a vehicle under conditions of extreme temperature, and then generating a warning.

2. Description of Related Art

News reports give us constant reminders of the fact that animals and humans are still constantly left in vehicles with the windows rolled up on a constant basis. The inside of an automobile can be heated by the greenhouse effect to temperatures well over 100 degrees F. and, frequently, over 130 degrees F. Mammals, humans, including children and babies, and basically everyone left in these conditions can easily suffer from heat stroke. Hundreds of children have died from being left in a car and suffering these conditions.

A number of methods have been developed for these conditions, but basically they are not utilized because of their incompleteness, or difficulty to use, or other such factors. These methods include sensors that measure temperature and measure the presence of a baby seat, or others where there are sensors built into the baby seat, which is then connected to the vehicle horn or some other vehicle alarm (like flashing lights). Obviously, not all children, and not all animals sit in child car seats, and many have car seats without the built in sensors, also a child in a car seat can climb out of the seat, so that such devices in car seats are of limited use. Nothing on the market at this point deals with enough of the parameters that could occur to assure the detection of the mammal (including humans) present in a car left unattended and at an unacceptable temperature.

### BRIEF SUMMARY OF THE INVENTION

The invention provides a complex sensor network to overcome the problems of the prior art situations. By not only measuring temperature, but also measuring all seats using weight sensing, as well as utilizing motion and sound detection and with it all connected to an externally sounding alarm, this method helps solve the problem of sensing a mammal in an overheated vehicle. In another aspect, the system is integrated into the vehicle electronic system rather than being separate from the vehicle electronics, or requiring purchase of a special child car seat with built in sensors.

Accordingly, in one embodiment, the present invention refers to a safety sensing system for detection of a mammal in an extreme temperature situation in a vehicle having seating comprising:
a) a temperature sensor;
b) at least two sensors for the detection of a mammal selected from the group consisting of:
   i. a load sensor beneath one or more of the vehicle seats;
   ii. a seatbelt closure sensor for each of one or more of the vehicle seatbelts;
   iii. a motion detector sensor;
   iv. a sound sensor;
   v. a heartbeat sensor;
   vi. an image sensor;
c) a microcontroller in communication with the sensors which determines from at least one of the mammal selecting sensors if there is a mammal in the vehicle at an extreme temperature; and
d) an alarm coupled with the microcontroller which is activated when the microcontroller determines there is a mammal in the vehicle at an extreme temperature.

In another embodiment, the present invention refers to a safety sensing system for detection of a mammal in an extreme temperature situation in a vehicle having seating comprising:
a) a temperature sensor;
b) a motion detector;
c) a microcontroller for reading the sensors and determining if there is a mammal in the vehicle at an extreme temperature; and
d) an alarm coupled with the microcontroller which is activated when the microcontroller determines there is a mammal in the vehicle at an extreme temperature.

### BRIEF DESCRIPTION OF THE DRAWINGS

FIG. 1 shows a perspective overview including wiring, showing the present invention.

FIG. 2 illustrates a perspective view minus wiring, showing the present invention.

FIG. 3 presents a schematic view, showing vehicle interfacing and how different inputs are gathered and their various outputs.

FIG. 4 shows an overview, showing how two optional methods of limited user control can be implemented.

FIG. 5 shows a perspective outline, showing the alarm system and its sequential steps to save a child.

### DETAILED DESCRIPTION OF THE INVENTION

While this invention is susceptible to embodiment in many different forms, there is shown in the drawings, and will herein be described in detail, specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### DEFINITIONS

The terms “about” and “essentially” mean ±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

References throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “safety sensing system” refers to an electronic system designed for a vehicle wherein when the driver leaves the vehicle, and a mammal is left in a passenger's compartment of the vehicle, and the temperature inside the vehicle raises or lowers to an extreme temperature (to such an extent that the mammal is in danger of being harmed), an alarm is sounded so that nearby people can rescue the mammal. The system is designed to operate regardless of whether the car is left running or has been shut off and the keys removed.

As used herein, the term “detection” refers to the ability to determine if there is a mammal in the vehicle by use of various sensors.

As used herein, the term “mammal” refers to a warm-blooded vertebrate animal such as a human, dog or cat or the like.

As used herein, the phrase “extreme temperature” refers to those temperatures above or below at which a mammal might be in jeopardy of being harmed. In one embodiment, it is 80 degrees F. on the high side, or about 40 degrees F. on the low side. One skilled in the art can further determine extreme temperatures depending on other factors, such as location, age of the mammal, and the like.

As used herein, the term “vehicle” refers to a motorized vehicle, such as a car, van, truck or the like, in which a mammal, such as a human, might ride in a passenger compartment, and might also be left behind in the passenger compartment in a seat, on the floor, or the like.

As used herein, the phrase “temperature sensor” refers to an electronic sensor that measures the air temperature in the passenger compartment of the vehicle. Such sensor might also include humidity measurement and the like.

As used herein, the phrase “load sensor” refers to devices under one or more of the seats which can detect the presence of a mammal, the presence of a mammal in a car seat by weight changes applied to the sensor, or movement of a mammal around on the seat or shifting in the seat and the like. In one embodiment, a child vehicle seat is set on a sensor of the present invention.

As used herein, the phrase “motion detector sensor” refers to the detection of movement within a particular space. In the present instance it refers to the passenger compartment. Motion detection can be by any convenient means, such as by infrared subject detection, or by light beam interruption, or the like. Infrared motion detection has the advantage of detecting living movement rather than non-living movement, thus decreasing the likelihood of a false positive detection.

As used herein, the phrase “sound sensor” refers to a microphone placed within the passenger compartment such that sounds of a mammal can be picked up. In one embodiment, the sound sensor can have software in the sensor or in the microcontroller, which distinguishes between sounds from a mammal and sounds that are outside the passenger compartment, or not from a mammal inside the passenger compartment.

As used herein, the phrase “heartbeat sensor” refers to a detector placed near or on a mammal in a position to detect the heartbeat of the mammal. Chest belts, finger cots, and the like are well known in the field of heartbeat detection, as an example.

As used herein, the phrase “image sensor” refers to a digital video camera such as that using a CCD. The video can be equipped with face recognition technology or other sensing software designed to detect the presence of a mammal, especially a human.

As used herein, the phrase “seatbelt sensor” is an electronic or magnetic sensor which detects the condition where the seatbelt is engaged or not.

As used herein, the term “microcontroller” refers to a single integrated circuit containing a processor core, memory, and programmable input/output peripherals. The present microcontroller is programmed to be in communication with each of the sensors so that the sensor can report to the microcontroller if it detects the presence of a mammal in the passenger compartment of the vehicle by detection from sensors when the temperature is above or below the extreme temperatures, thus determining that there is a mammal in the vehicle at an extreme temperature. Communication can be hardwired or wireless and the microcontroller can be part of the standard vehicle construction, where all or part the sensors report to the controller. The connection to the vehicle's sensor system can be by any means, such as by connection to the CAN port of the vehicle, the bus. Local Interconnect Network or other like vehicle communication network or like connection. Wireless connections (e.g. using a IEEE 802.11 wireless chipset) are also useful depending on the location of the sensor or f the sensor is a factory specification or an add-on sensor, The microcontroller is programmed to turn on an alarm if the sensors detect the presence of a mammal at extreme temperatures and, in most conditions, while the vehicle is not moving or turned off. In one embodiment, the microcontroller does not sound an alarm unless it gets a signal of a positive presence of a mammal from at least two of the sensors. This feature helps prevent false positives in the reporting of the presence of a mammal.

As used herein, the phrase “vehicle's sensor system” refers to those sensors which come as a part of the vehicle as it comes from the factory. Typical sensors include those that have other purposes, such as seatbelt locking detectors for detecting if a person riding in the car has the seatbelt on as required by law. Passenger compartment temperature sensors are routinely included in vehicle factory components. However, one embodiment of the invention is that most, if not all of the sensors utilized in a device, are factory installed into the vehicle rather than as an add-on device. Vehicles coming with the system as standard equipment will mean drivers will have the device as a stock feature and will thus reduce the incidences of mammals left in cars at extreme temperatures.

As used herein, the term “alarm” refers to a sound or visual (such as a message or light or the like) which occurs to alert people that there is a mammal in the vehicle, and that the temperature inside is an extreme temperature. In most cases, it is designed such that people near the vehicle will come to the vehicle, such as shoppers in a parking lot. In other embodiments, it is designed to bring the authorities (police, fire, rescue and the like) to the scene to make entry into the vehicle and remove or rescue the mammal. In other embodiments, the driver or other contacts are notified to come to the vehicle. Non-limiting examples include; sounding of the vehicle horn, flashing of the vehicle lights, sending a message to the driver and/or contacts, sounding a siren, using a public address system which gives a recorded message, sending a message to public authorities, a door ajar message noting a child/mammal present, and the like. The message can be sent to a computer, a smartphone, smartwatch, or the like. In one embodiment, the activation of the alarm also activates unlocking one or more doors of the vehicle to make entry easy to the vehicle for rescue of the mammal. In one embodiment, the system has GPS capabilities (global positioning) such that an alarm can inform authorities or others of the vehicle's location.

As used herein, the phrase “message being sent automatically” refers to the system also including device or devices for communication of voice or text messages over, for example, a Wi-Fi system, a cellular system, text messaging system and the like, to authorities, the vehicle owner, or driver, or anyone of interest.

As used herein, the phrase “alert signal” refers to a beep, ring, or other audio or visual signal that tells a vehicle driver that there is a mammal in the car as the car is being turned off and the driver is exiting the vehicle.

Sensors are located at any convenient location, as is the microcontroller and alarm systems of the present invention. One of skill in the art in view of this disclosure could find the appropriate place to locate the system. Generally, these locations are inside the car passenger compartment under the hood inside the truck or the like but could if desired be located outside the vehicle as desired.

### THE DETAILED DESCRIPTION OF THE DRAWINGS

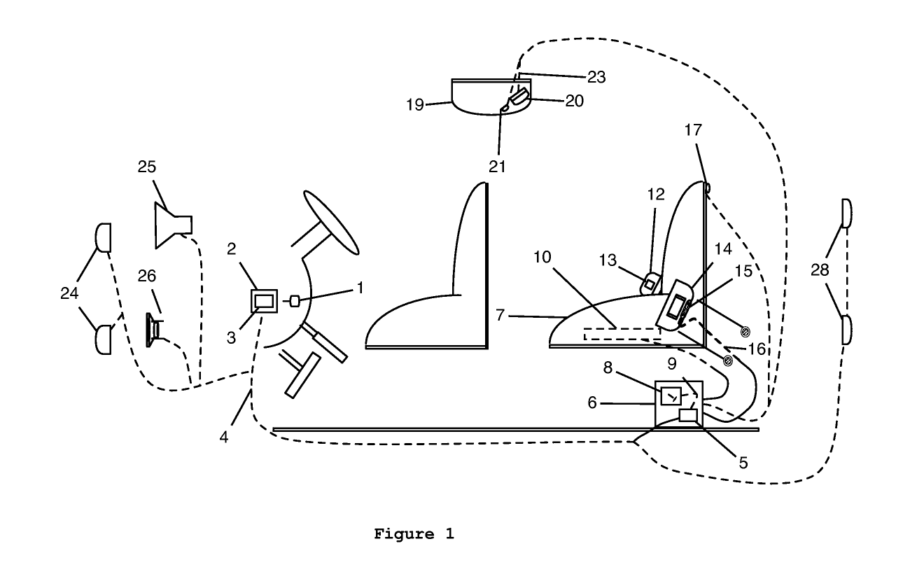

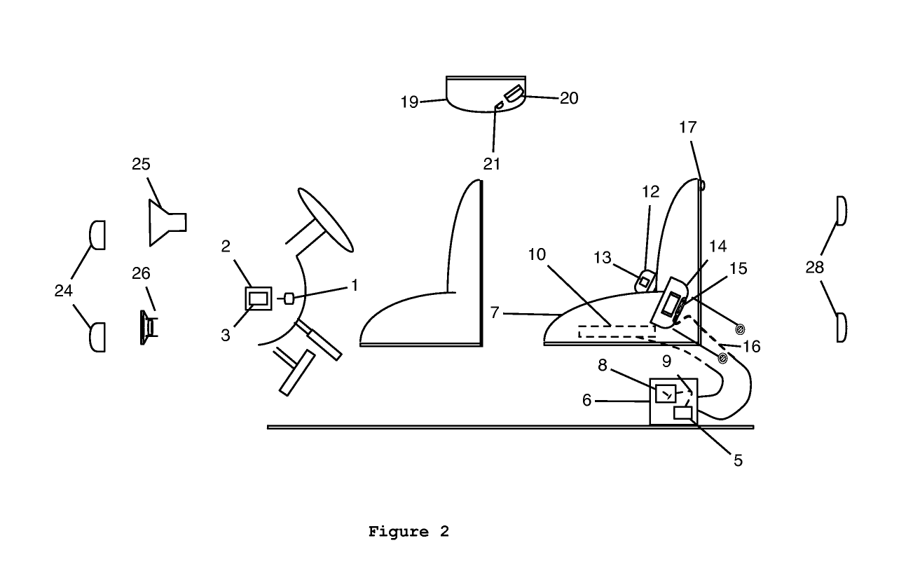

FIG. 1 and FIG. 2 show a perspective view of an embodiment of the present invention. The safety system invention begins with the passenger compartment vehicle enclosure 6, which contains the microcontroller 5. The microcontroller is configured to be attached to a CAN vehicle interface 1 and wiring to various sensors of the present invention. The vehicle interface wiring 4 shows wiring from vehicle interface 3 to microcontroller 5. The vehicle interface 3 is, in this embodiment, inside the dash within an enclosure 2 wired to the vehicle CAN bus. The microcontroller 5 is configured to be attached beneath rear seating in this embodiment. In one embodiment, the vehicle interface 3 and the microcontroller 5 are located within the dash in one enclosure; thus, allowing for single point of installation and maintenance.

Reed sensor wiring 16 shows wiring embedded into rear seatbelts for seatbelt locking detection. The number of seatbelts varies with vehicle rear seating arrangements. The seatbelt wiring embodiment shown is to be embedded within the seatbelt weaving where rear seatbelt clasp 12 is shown. There are numerous possibilities of manufacture and install for the reed sensor seatbelt. The magnetic reed sensor 15 is shown embedded inside of the seatbelt buckle 14. The seatbelt clasp has a matching magnet 13 embedded in the tip of its clasp. The seatbelt clasp, once fastened, reacts with the magnetic reed sensor in the buckle. The reed sensor, once engaged, informs the microcontroller via the reed sensor wiring to engage and monitor the system for further checks via other sensors. The system goes into a ready state and the microcontroller will monitor the matching weight sensor 10 located in seating of fastened seatbelt for 70 pounds or less. If so, other checks are made to engage the system, which indicate a child/mammal is present in the rear seat.

The number of load cells varies with the number of rear seating arrangements and this varies with car, van, and SUVs. The weight sensor is embodied within the rear seats 7 in this embodiment. The load cell has two operations in this embodiment. One operation is to monitor if the rear seat belt is fastened and inform the microcontroller if the weight is 70 pounds or less. The load cell's second operation is to monitor when the system is in an idle state. The idle state is one in which no child is present. If weight is detected, other checks are made. This works with the motion sensor 20 to detect a child that has been left but that is no longer using an attached seatbelt, and via other checks determines if the child is alone.

One important check when weight is detected is the motion sensor 20. The embodiment is within the light dome 19 of the automobile in this embodiment. The wiring 23 of the motion sensor is through the light dome wiring path reaching the microcontroller. The motion sensor when the system is idle and in cooperation with the weight sensor monitors for movement.

In coordination with the system engaging a state of child (or other mammal) on board is the temperature sensor 8 which will work in addition to automobile temperature sensors in one embodiment. The safety device temperature sensor 8 will be wired 9 to the microcontroller 5. The temperature sensor 8 informs the microcontroller 5 of ambient passenger compartment temperature. If the temperature reaches extreme temperatures, in combination with weight sensor or seatbelt sensor detection, the system will expedite emergency measures for a child left in the vehicle.

The microphone sensors 17 and 21 will be wired into the microcontroller 5. The microphone sensors 17 and 21 will be amplified once the system determines it to be in an idle state. The microphone sensors 17 and 21 work with or without the weight sensor and seatbelt sensor. An urgent example is if a child is left alone and asleep, the microphone sensors 17 and 21 listen for subtle breathing, snoring, and any ruffles of noise, as the interior of the car should be silent. If the microphone sensors 17 and 21 detect any noise in combination with the weight sensor or seatbelt sensor detection, the system expedites countdown to emergency measures. If interior noise is detected and the system was in idle state, emergency measures may be taken.

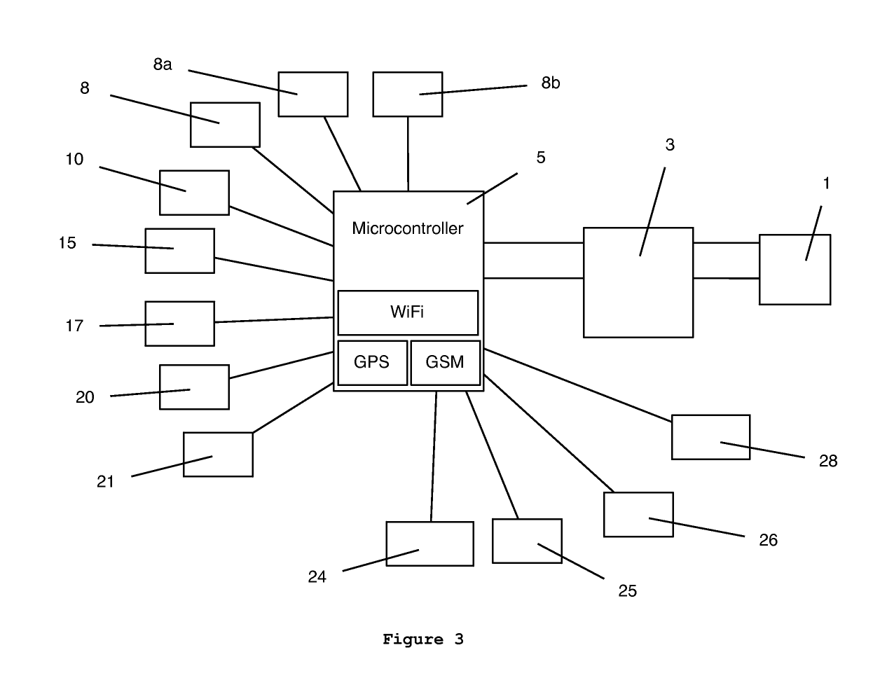

FIG. 3 shows how the various sensors are wired to the system microcontroller 5. This embodiment also shows heartbeat sensor 8a and image sensor 8b. The microcontroller 5 should have a high ambient and operating temperature, as well as extreme low temperatures as discussed above. For example, magnets lose power in extreme temperatures. One optional reed sensor investigated for the invention can with stand −60° C. to 250° C. The invention has been developed specifically for the vast range of temperatures it will endure. Backup power will be afforded the microcontroller 5 if automobile power fails. The load cell can be constructed via strain gauges and an op-amp. The microcontroller 5 will use precise calculations to ensure proper weight data for the system. Different types of motion sensors and microphone sensors are viable alternatives. Seat belt manufacture is numerous as well. The main factor is quality and operating temperatures of the components, including the wiring. The PA system 26 can be any PA system that is loud enough to assist the horn in warning the driver or passersby of a kid or other mammal in emergency.

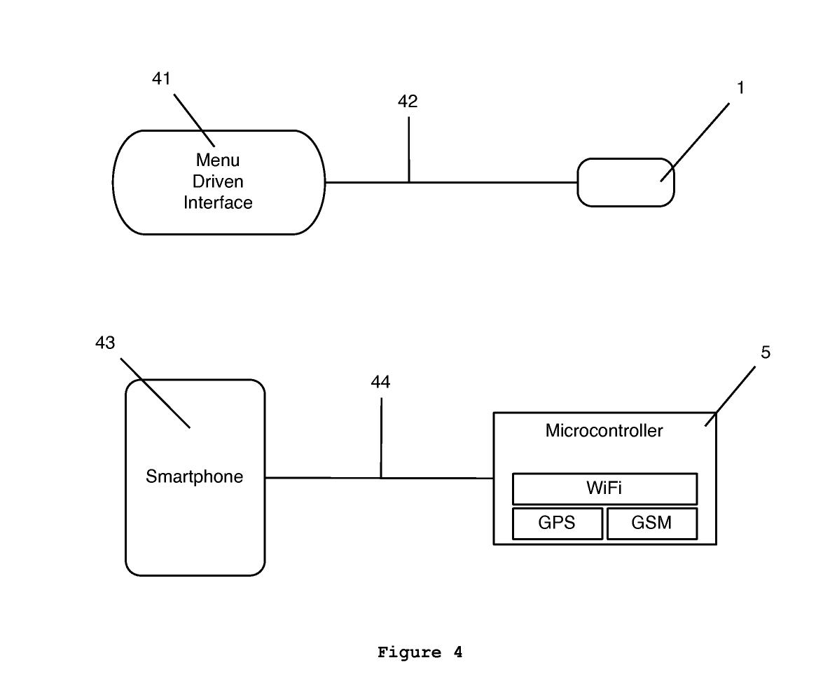

As the system is designed for safety, In FIG. 4 the system has in one embodiment, user controls. In one embodiment there will be two systems of user control. Looking at FIG. 4, for automobiles without smartphone application ability, a menu driven interface 41 is wired 42 to the CAN port 1 as needed and removed upon completion. For smartphone 43 application ready automobiles, an app can be implemented to set variables for the system wirelessly 44. The user can set driver's phone numbers for texts by system. The user can ultimately disable the system (removing the safety device from operation), per specific instructions of safety risks in doing so and as current and future laws permit. For smartphone apps, the user can also disengage the system (temporarily disarming the system) once per system engagement. An important example is where the system is engaged and the driver pulls over to assist an emergency, the child should not have to be removed while the parent assists others in need only a couple of meters away; hence, child has not been left alone. The user can disengage the system; however, once the automobile begins again, the system will reengage automatically. Two common examples where disengagement (temporary) or disabling (permanent) is valid is when a child is no longer able to be trapped in a vehicle (able to sustain themselves as needed) and/or when individuals commute with pets.

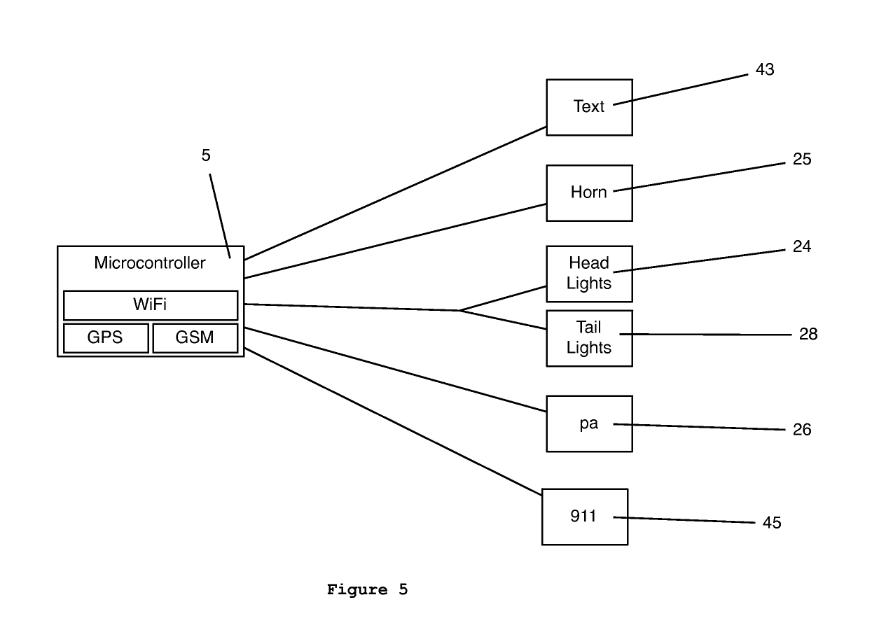

FIG. 5 is a schematic representation of the alarms controlled by microcontroller 5. In this view, the microcontroller 5 controls texting 43, horn 25, headlights 24, tail lights 28, public address system 26 and messages to public authorities (e.g. 911) 45.

The following is an example of the steps taken if a child or mammal is in an extreme temperature emergency in the vehicle. The present invention is based off of various states of child/mammal in emergency state or an okay state. As an example, one state begins when a rear seatbelt fastens. Next, a weight sensor detects 35 pounds in the seat beneath the fastened seatbelt. Next, the system detects a weight of 90 pounds in an adjacent rear seat. The system returns to monitoring as currently the child is not alone. Another state is when the car is cranked in the morning for warm-up. A child is placed in car. The system engages and is aware that the car is running, is idle, no driver or passenger is in front seating, and seatbelt or weight determines a child is present and alone. The driver forgets something in the house and returns to promptly retrieve it, as such, the system will begin its emergency countdown of a predetermined amount of time. Another example occurs when a baby is placed in a baby car seat (the system is smart enough to account for tare weight as the seatbelt remains in fastened state). The weight sensor detects 14 pounds. The weight sensor will check and find that the seatbelt is indeed fastened. It will check if the driver and/or passenger seatbelt is fastened and/or the ignition is engaged and/or if the speedometer is currently above 0. These and other checks are handled by the software and ensure child is in an okay state; if not, a child in an emergency state is the top priority and the system runs various checks before setting alarms. A final example occurs if a driver leaves a child with the window down. The temperature sensor will still detect ambient temperatures in the immediate area. If, while the window is down, the child falls into a smaller weight category, the system will engage. A window down does not prevent dangers to small children and the countdown timer will expedite due to temperature concerns. Countdown timers vary with the temperature, the weight of the child, and other measures. A typical timer is 300 seconds. This allows ample time for the driver or other passenger to exit the vehicle and retrieve a child during a normal commute. The temperature and weight of the child are able to expedite this timer to as short as 120 or less seconds during a “run-in, be right back” scenario. Research has shown that vehicle temperatures can rise 20° in 10 minutes and continues rising from there. Depending on the current temperature and the weight of the baby or child, the present invention will not allow certain time thresholds to pass without engaging the alarm system. The alarm system, if allowed to countdown, begins with a text if available. If the triggering issues are not resolved after the text, the horn will begin lightly blowing. If, in the next cycle (cycles, once countdown initializes, emergency procedures are in milliseconds), the child is still in an emergency situation, all exterior lights will begin flashing with the PA system announcing a child in an emergency. If the system is near wireless access, it will be able to text 911 45 car location (GPS coordinates) and car information (color, model, and license plates). If ubiquitous and free Wi-Fi is not available, the secondary communication method (Global System for Mobile Communications—GSM) initiates. The GSM chip uses e.g. cellular service to SMS or SMS-to-text current car location (GPS coordinates) and aforementioned car information.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A safety sensing system for detection of a mammal in an extreme temperature situation in a vehicle having seating comprising:
a) a temperature sensor;
b) at least two sensors for the detection of a mammal selected from the group consisting of:
i. a load sensor beneath one or more of the vehicle seats;
ii. a seatbelt closure sensor for each of one or more of the vehicle seatbelts;
iii. a motion detector sensor;
iv. a sound sensor;
v. a heartbeat sensor;
vi. an image sensor;
c) a microcontroller in communication with the sensors which determines from at least one of the mammal selecting sensors if there is a mammal in the vehicle at an extreme temperature; and
d) an alarm coupled with the microcontroller which is activated when the microcontroller determines there is a mammal in the vehicle at an extreme temperature.

2. The safety sensing system according to claim 1 wherein the system further comprises a connection to the vehicles sensor system.

3. The safety system according to claim 2 wherein the connection is via the vehicle's CAN port, CAN bus, Local Interconnect Network, or other vehicle communication networks.

4. The safety system according to claim 2 wherein the vehicle's sensor system provides at least one of the sensors of the safety sensing system.

5. The safety sensing system according to claim 4 wherein all the sensors of the safety sensing system are provided by the vehicle's sensor system.

6. The safety sensing system according to claim 1 wherein the alarm comprises at least one of the alarms from the list comprising:
a) sounding of the vehicle horn;
b) flashing of the vehicle lights;
c) a siren;
d) a public address system; and
e) a message sent to public authorities.

7. A safety sensing system according to claim 1 wherein the system further comprises a message being sent automatically to a selected individual or group when the alarm is activated other than the public authorities.

8. The safety system according to claim 1 wherein once the alarm is activated the alarm cannot be turned off unless a door of the vehicle is opened.

9. The safety system according to claim 1 wherein at least one door is automatically unlocked when the alarm is activated.

10. The safety system according to claim 1 which further comprises an alert signal initiated if a vehicle driver is leaving the vehicle and the system detects a mammal other than the driver present in the vehicle.

11. The safety system according to claim 1 wherein the system further comprises at least one from the group consisting of a location detection system, a cellular communication system and a Wi-Fi communication system.

12. A safety sensing system for detection of a mammal in an extreme temperature situation in a vehicle having seating comprising:
a) a temperature sensor;
b) a motion detector;
c) a microcontroller for reading the sensors and determining if there is a mammal in the vehicle at an extreme temperature; and
d) an alarm coupled with the microcontroller which is activated when the microcontroller determines there is a mammal in the vehicle at an extreme temperature.

13. The safety sensing system according to claim 12 wherein the system further comprises a connection to the vehicle's sensor system.

14. The safety system according to claim 13 wherein the connection is via the vehicle's CAN port, CAN bus, Local Interconnect Network, or other vehicle communication networks.

15. The safety system according to claim 13 wherein the vehicle's sensor system provides at least one of the sensors of the safety sensing system.

16. The safety sensing system according to claim 15 wherein all the sensors of the safety sensing system are provided by the vehicle's sensor system.

17. The safety sensing system according to claim 12 wherein the alarm comprises at least one of the alarms from the list comprising:
a) door-ajar-child-present beeping upon exit;
b) message sent to the driver of the vehicle;
c) message sent to contacts;
d) sounding of the vehicle horn or flashing the vehicle lights;
e) flashing of the vehicle lights;
f) a siren;
g) a public address system; and
h) a message sent to public authorities.

18. A safety sensing system according to claim 12 wherein the system further comprises a message being sent automatically to a selected individual or group when the alarm is activated.

19. The safety system according to claim 12 wherein once the alarm is activated the alarm cannot be turned off unless a door of the vehicle is opened.

20. The safety system according to claim 12 which further comprises an alert signal initiated if a vehicle driver is leaving the vehicle and the system detects a mammal other than the driver present in the vehicle.

21. The safety system according to claim 12 wherein at least one door is automatically unlocked when the alarm is activated.
